(19) United States
(12) Patent Application Publication
(10) Pub. No.: US 2011/0208577 A1
(43) Pub. Date: Aug. 25, 2011

(54) Online Offer Distribution System And Mehtod

(75) Inventors: John Lieblang, Clarkston, MI (US); Darryl Hogan, Windsor (CA); John Detwiler, Lewis Center, OH (US)

(73) Assignee: VALASSIS COMMUNICATIONS, INC., Livonia, MI (US)

(21) Appl. No.: 13/032,991

(22) Filed: Feb. 23, 2011

Related U.S. Application Data
(60) Provisional application No. 61/307,201, filed on Feb. 23, 2010.
(60) Provisional application No. 61/390,841, filed on Oct. 7, 2010.

(51) Int. Cl. G06Q 30/00

(52) U.S. Cl. 705/14.39

(57) ABSTRACT

An online offer distribution system may convey offer information relating to an offer selected from an offer supply database. The offer information may be conveyed in an electronic form, such as a web page, that may be accessed by a consumer on a client device. Upon receiving a request to print an offer document corresponding to the offer, the system may generate the offer document including at least a portion of the offer information and time indicating indicia associated with the request to print. The time indicating indicia may be a quasi-unique identifier corresponding to a time the request to print is received or the offer document is transmitted to the client device for printing. The time indicating indicia may be encrypted and incorporated into the offer document as an alphanumeric code, barcode, or both.

### CROSS-REFERENCE TO RELATED APPLICATIONS

This application claims the benefit of U.S. provisional Application No. 61/307,201, filed Feb. 23, 2010, and U.S. provisional Application No. 61/390,841, filed Oct. 7, 2010, the disclosures of which are incorporated in their entirety by reference herein.

### TECHNICAL FIELD

The following generally relates to a system and method for distributing offers online for printing by consumers, and in particular to printed offer documents corresponding to the offers.

### BACKGROUND

The advent of the Internet has revolutionized many industries, including the couponing industry. Offer providers can distribute offers digitally, for example, in an email or on a website. Digital offers refer to coupons, vouchers or other incentives that exist electronically. Rather than manually clipping coupons from newspapers or advertisement with a pair of scissors, consumers can access the digital offers from the website and select which offers to print.

### SUMMARY

According to one or more embodiments of the present application, a computer-implemented method for distributing an offer is provided. The method may include generating an electronic form for displaying offer identifying information relating to the offer on a client device and receiving a request from the client device to print an offer document corresponding to the offer. The method may further include generating the offer document including time indicating indicia associated with the request to print and transmitting the offer document to the client device for printing with the time indicating indicia.

The time indicating indicia may be associated with the time the request to print is received. Alternatively, the time indicating indicia may be associated with the time the offer document is transmitted to the client device or the time the offer document is printed. The time indicating indicia may be a quasi-unique identifier. The time indicating indicia may represent a time to within a fraction of a second. Moreover, the time indicating indicia may be encrypted. The time indicating indicia may correspond to an alphanumeric code printed on the offer document. Additionally, the time indicating indicia may be integrated into a barcode.

According to one or more embodiments, the time indicating indicia may be associated with a Julian date code. Moreover, the time indicating indicia may be generated from an encryption of the Julian date code. Alternatively, the time indicating indicia may be associated with a tick count. The method may further comprise generating a transaction record associated with the print request including the offer identifying information and the time indicating indicia and storing the transaction record in a database.

According to one or more additional embodiments of the present application, a computer system for distributing an offer is provided. The computer system may include a computer and a database that are in electronic communication with each other. The computer system may have a central processing unit (CPU) for executing machine instructions and a memory for storing machine instructions that are to be executed by the CPU. The machine instructions when executed by the CPU may implement the function of generating a web page for displaying offer identifying information relating to the offer on a client device. It may further implement the functions of receiving a request from the client device to print an offer document corresponding to the offer, generating the offer document including at least a portion of the offer identifying information and time indicating indicia associated with the request to print, and transmitting the offer document to the client device for printing with the time indicating indicia.

According to one or more additional embodiments of the present application, an offer document for printing at a client device is provided. The offer document may include offer identifying information corresponding to an offer and time indicating indicia associated with a request to print the offer document.

### BRIEF DESCRIPTION OF THE DRAWINGS

FIG. 1 is a simplified, exemplary block diagram of an online offer distribution system in accordance with one or more embodiments of the present application;

FIG. 2 is a simplified, exemplary block diagram of a computing device in accordance with one or more embodiments of the present application;

FIG. 3 is a simplified, exemplary information flow diagram in accordance with one or more embodiments of the present application;

FIG. 4 depicts an exemplary user interface displaying offer identifying information in accordance with one or more embodiments of the present application;

FIG. 5 depicts an exemplary offer document corresponding to the offer identifying information displayed in FIG. 4; and

FIG. 6 is a simplified, exemplary flow chart for an online offer distribution system in accordance with one or more embodiments of the present application.

### DETAILED DESCRIPTION

Detailed embodiments of the present invention are disclosed herein. However, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Implementations of illustrative embodiments disclosed herein may be captured in programmed code stored on machine readable storage mediums, such as, but not limited to, computer disks, CDs, DVDs, hard disk drives, programmable memories, flash memories and other permanent or temporary memory sources. Execution of the programmed code may cause an executing processor to perform one or more of the methods described herein in an exemplary manner.

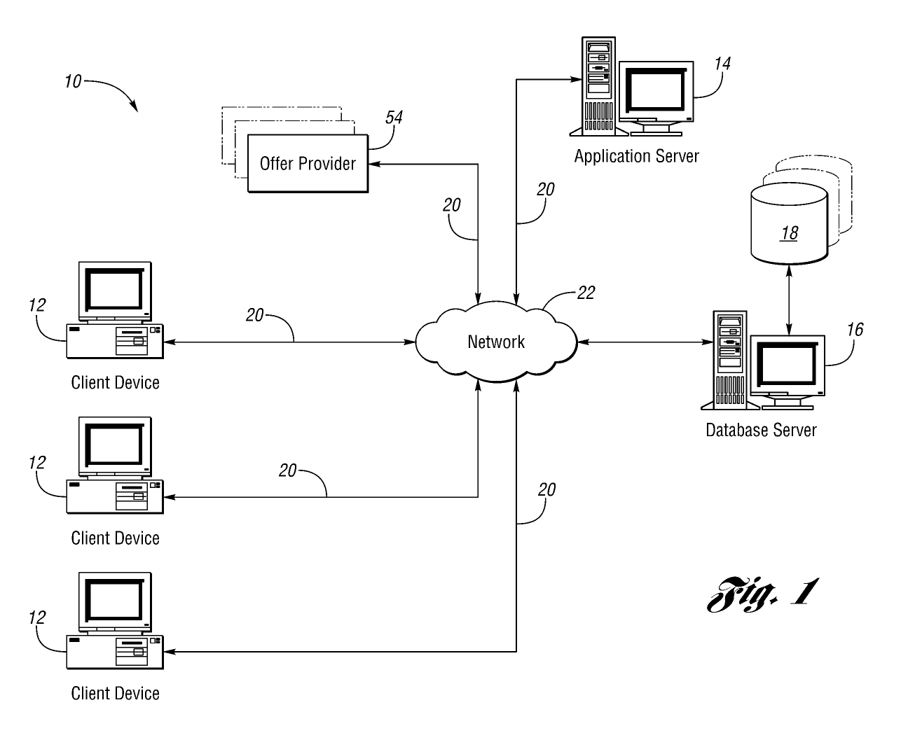

A high-level block diagram of an exemplary online offer distribution system 10 is illustrated in FIG. 1. In one embodiment, the offer distribution system 10 can be implemented as a networked client-server communications system. To this end, the system 10 may include one or more client devices 12, one or more application servers 14, and one or more database servers 16 connected to one or more databases 18. Each of these devices may communicate with each other via a connection to one or more communications channels 20. The communications channels 20 may be any suitable communications channels such as the Internet, cable, satellite, local area network, wide area networks, telephone networks, or the like. Any of the devices described herein may be directly connected to each other and/or connected over one or more networks 22. While the application server 14 and the database server 16 are illustrated as separate computing devices, an application server and a database server may be combined in a single server machine.

One application server 14 may provide one or more functions or services to a number of client devices 12. Accordingly, each application server 14 may be a high-end computing device having a large storage capacity, one or more fast microprocessors, and one or more high-speed network connections. One function or service provided by the application server 14 may be a web application, and the components of the application server may support the construction of dynamic web pages.

One database server 16 may provide database services to the application server 14, the number of client devices 12, or both. Information stored in the one or more databases 18 may be requested from the database server 16 through a “front end” running on a client device 12, such as a web application. On the back end, the database server 16 may handle tasks such as data analysis and storage.

Relative to a typical application server 14 or database server 16, each client device 12 may typically include less storage capacity, less processing power, and a slower network connection. For example, a client device 12 may be a personal computer, personal digital assistant (PDA), mobile phone and/or any other suitable computing device. The client device 12 may be configured to run a client program such as a web browser that can access the one or more functions or services provided by the application server 14. Moreover, the client device 12 may access information or other content stored at the application server 14 or the database server 16.

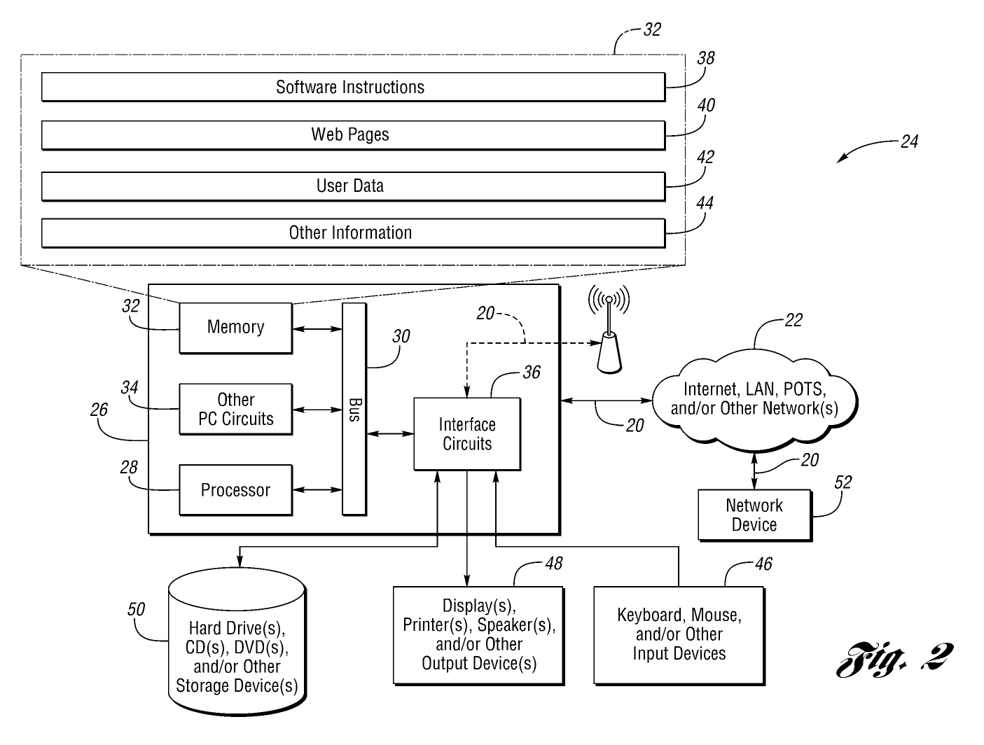

A detailed block diagram of an exemplary computing device 24 is illustrated in FIG. 2. One or more attributes of the exemplary computing device 24 may be present in a client device 12 or a server, such as the application server 14 or the database server 16. In particular, each computing device 24 may include a main unit 26 which itself may include one or more processors 28 electrically coupled by an address/data bus 30 to one or more memory devices 32, other computer circuitry 34, and/or one or more interface circuits 36. The processor 28 may be any suitable microprocessor.

The memory device 32 may include volatile memory and nonvolatile memory. The memory device 32 and/or another storage device may store software instructions 38 that interact with the other devices in the system 10 as described herein. The software instructions 38 may be executed by the processor 28 in any suitable manner. The memory device 32 and/or another storage device may also store one or more data structures, digital data indicative of documents, files, programs, web pages, and the like retrieved from another computing device and/or loaded via an input device.

The exemplary memory device 32 may store software instructions 38, web pages 40, user data 42, and other information 44 for use by the system 10 as described in detail below. Many other data fields or records may be stored in the memory device 32 to facilitate implementation of the system and methods disclosed herein. In addition, any type of suitable data structure (e.g., a flat file data structure, a relational database, a tree data structure, etc.) may be used to facilitate implementation of the system and methods disclosed herein.

The interface circuit 36 may be implemented using any suitable interface standard, such as an Ethernet interface and/or a universal serial bus (USB) interface. One or more input devices 46 may be connected to the interface circuit 36 for entering data and commands into the main unit 26. For example, the input device 46 may be a keyboard, mouse, touchscreen, trackpad, trackball, isoprint, voice recognition system, or the like.

One or more displays, printers, speakers, and/or other output devices 48 may also be connected to the main unit 26 via the interface circuit 36. The display 48 may be a cathode ray tube (CRT), liquid crystal display (LCD), or any other suitable display. The display 48 may generate visual displays of data generated during operation of the computing device 24. For example, the display 48 may be used to display electronic forms such as web pages received from the application server 14 on a client device 12. The visual displays may include prompts for user input, runtime statistics, calculated values, data, etc.

One or more storage devices 50 may also be connected to the main unit 26 via the interface circuit 36. For example, a hard drive, CD drive, DVD drive, flash memory drive, and/or other storage devices 50 may be connected to the main unit 26. The storage devices 50 may store any type of data used by the computing device 24.

Each computing device 24 may also exchange data with other computing devices and/or other network devices 52 via a connection to the communication channels 20. The communication channels 20 may be any type of network connection, such as an Ethernet connection, WiFi, WiMAX, digital subscriber line (DSL), telephone line, co-axial cable, or the like.

Referring back to FIG. 1, the online offer distribution system 10 may provide a secure platform for distributing offers (e.g., promotions, coupons, incentives, etc.) online to a large number of consumers for subsequent redemption at a point of sale (POS) location. The disclosed system may include controls and other appropriate security features to prevent and/or minimize the fraudulent use of offers distributed online in this manner. For example, the system 10 may employ security features that can prevent the unauthorized viewing, copying, modifying, printing, screen grabbing, saving and distributing of offers that is prevalent with online content today.

According to one or more embodiments of the present application, the application server 14 may provide a user (e.g., a consumer) web access to offers made available online by one or more offer providers 54. An offer provider 54 may include a consumer packaged goods manufacturer (CPG), a retailer, a service provider, a restaurant, or other similar entity that may distribute offers to consumers. In addition to distributing offers, the one or more application servers 14 of one or more embodiments of the present system may also aggregate and/or manage the offers created by the one or more offer providers 54. Correspondingly, the application server 14 may also provide a web portal for offer providers 54 to generate, edit and manage offers according to their own business rules. In such an embodiment, the offer providers 54 may also function as clients in the disclosed system.

The disclosed offer management and distribution platform may allow an offer provider 54 access to one or more application programming interfaces (APIs) to give the offer provider more control and flexibility over its incentivizing initiatives. For instance, campaign-based print limits and/or device-based print limits may be imposed on an offer created by the offer provider 54. The system 10 may also provide reporting features including options to provide offer information in real-time to offer providers 54. Accordingly, an offer provider 54 may be able to track consumer printing and redemption of offers. The system 10 may allow offer providers 54 to track items such as consumer views, prints, redemptions, the geographic distribution of offers, and the like. However, according to one or more embodiments, the system 10 may not directly associate an offer to a specific consumer.

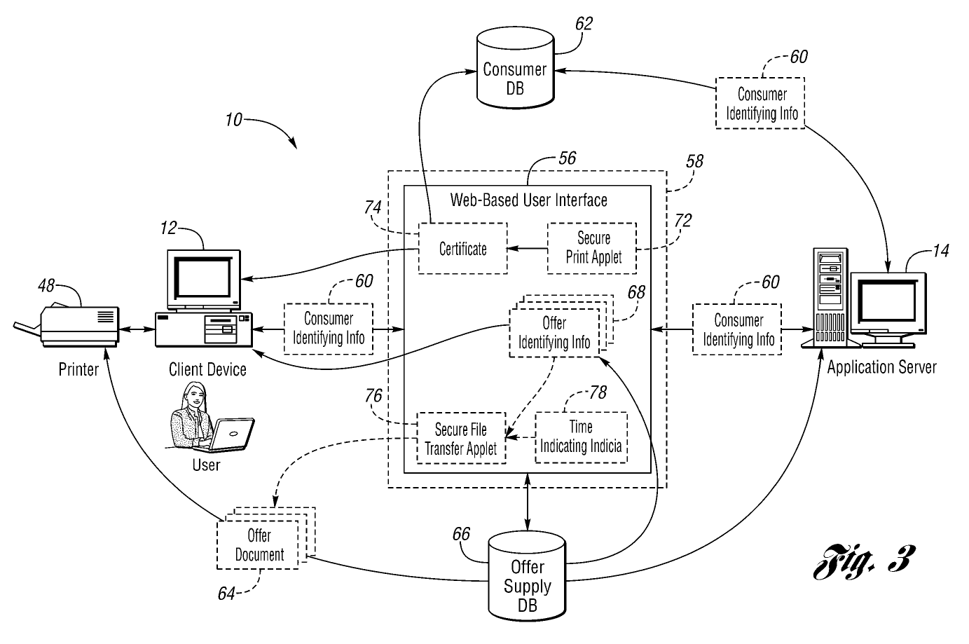

With reference now to FIG. 3, an exemplary information flow diagram corresponding to a portion of an online offer distribution system 10 is illustrated. As seen therein, the system 10 may include a web-based user interface 56 hosted by the application server 14 and executed on the client device 12 (e.g., a consumer computing device). The user interface 56 may be a web portal for aggregating offers from the one or more offer providers 54 into a single website. Accordingly, a user (i.e., consumer) may visit an online offer distribution website to view and potentially print content corresponding to available offers. The online offer distribution website may include electronic forms such as web pages 40 conveying offer content relating to one or more digital offers. The online offer distribution website may be a website provided by a CPG, retailer, service provider, third-party offer aggregator, or the like. The user interface 56 may run in a browser 58 on the client device 12.

The user may be required to register with the application server 14 and establish a user account in order to gain access to the offers made available by the system 10 on the offer distribution website. In such an instance, the user may choose a consumer identifier (e.g., a user name, e-mail address, etc.) and a password which may be required for the activation of offer distribution services. The consumer identifier and password may be passed across the communication channels using encryption built into the user's browser, software application, or computing device (e.g., the client device). Alternatively, the consumer identifier and/or password may be assigned by the application server. Consumer identifying information 60 including the consumer identifier and/or password may be stored in a consumer database 62 provided on the database server 16.

In a process independent of the exemplary registration process described above, a number of offer documents 64 may be created to obtain an inventory of offer documents retained in an offer supply database 66. The number of offer documents 64 may correspond to offers made available online from the one or more offer providers 54. Alternatively, a number of digital offer records relating to the number of offers may be stored in the offer supply database 66 and an offer document 64 corresponding to an offer for which a print request is received may be generated. The offer supply database 66 may also be provided on the database server 16 and accessed by the user interface 56 and/or application server 14. Moreover, the offer supply database 66 may include rules for when an offer document 64 should be issued and who it should be issued to. Offer documents 64 may be automatically expired in the offer supply database 66 based on predefined conditions such as a certain date, after a number of days, after a number of views, or after a number of prints.

The user interface 56 may issue an available offer from the number of offer documents 64. In other words, offer identifying information 68 corresponding to an offer document 64 from the offer supply database 66 may be transmitted to the client device 12 for display to the consumer after the client device has been authenticated. However, the actual offer document 64 may not be displayed on the client device 12.

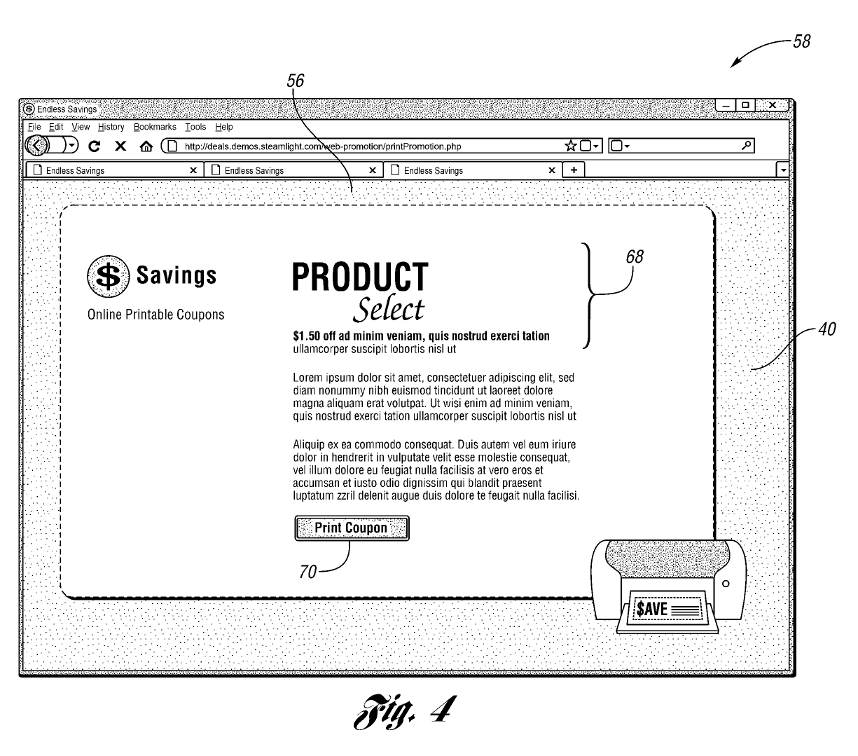

An exemplary web page 40 from an offer distribution website is illustrated in FIG. 4. As seen therein, the user interface 56 may display the offer identifying information 68 corresponding to an offer document 64 for selection by the user. The offer identifying information 68 may correspond to a particular offer available from the offer supply database 66, but the actual offer document 64 to be printed may not be displayed. Instead, an interface element 70 such as a print button may be provided on the user interface 56 for selection by the user. While the offer identifying information 68 for only a single offer document is illustrated in FIG. 4, offer identifying information corresponding to a number of offer documents may be displayed at a time for selection by the user.

With reference back to FIG. 3, the print button may launch a secure print function, a secure file transfer function, or both. To this end, the system 10 may further include a secure print applet 72 contained in a web page displaying the print button. Selection of the print button through the user interface 56 may cause the secure print applet 72 to be deployed to the client device 12 and executed by the browser 58. The deployment process may include the step of transmitting from the application server 14 a unique certificate 74 for the secure print applet 72 to the client device 12. The unique certificate 74 may identify the secure print applet 72. This transmitting step may occur before the client device 12 is enabled to receive any offer documents 64 as set forth below. Also, this transmitting step may occur after the user has registered with and/or logged in to the application server 14 by providing consumer identifying information 60. The authentication process may be largely transparent to the user. For instance, the user may only be prompted to confirm acceptance of the secure print applet 72.

The unique certificate 74 may be stored on the client device 12. For instance, the unique certificate 74 may be stored in the memory device 32. Additionally, the unique certificate 74 may be stored in the consumer database 62 on the database server 16 that is in communication with the client device 12 over the network 22. In one or more embodiments, a different unique certificate may be associated with a given user in the consumer database 62. For example, the same user may use the system 10 via the user interface 56 from different client devices. The unique certificate 74 may be matched at the time that the client device 12 executes the web-based user interface 56 to authenticate the client device 12 to enable secure printing of offer documents 64 through the web-based user interface 56 via the secure print applet 72.

A secure file transfer applet 76 may also be launched at the client device 12 when the user selects and submits offers to be sent to a local printer 48. The secure print applet 72 may verify that the local printer 48 is indeed a valid output device that contains paper as the only output within the print driver. The unique certificate 74 may load quickly and can ensure that all security controls are in effect. Upon launch of the secure file transfer function, the offer document 64 may not be displayed on the display screen of the client device 12. Rather, the user may simply be prompted to select a valid local printer 48 and allowed to print a predetermined number of copies of the offer document 64 based on business rules established by the associated offer provider 54. As previously described, such business rules may include campaign-based print limits or device-based print limits, or both.

The secure file transfer function may also employ controls to prevent the offer document 64 from being saved to the client device 12. Moreover, the secure file transfer function may prevent the use of print screen and screen grabber applications by not visually displaying the offer document 64 on the client device 12. The secure file transfer function may also prevent printing to file, printing to PDF or the use of other common image printers.

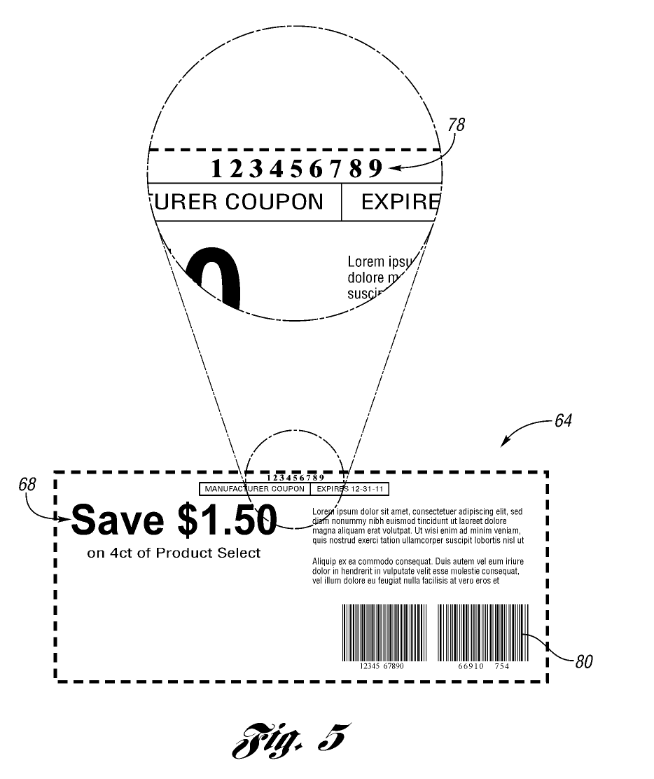

On an authenticated client device 12, the secure print applet 72 may enable secure printing of an issued offer document 64. With reference to FIG. 5, the printed offer document 64 may include offer content such as logos and other images, text, UPC bar codes, expiration dates, and the like. The offer content may include at least a portion of the offer identifying information 68. According to one or more embodiments of the present application, the printed offer documents 64 may further contain time indicating indicia 78. The time indicating indicia 78 may indicate the time and/or date at which the offer document 64 was printed or was requested to be printed. Alternatively, the time indicating indicia 78 may indicate when the offer document 64 was distributed or transmitted to a client device 12 for print. As used herein, any reference to a time with which the time indicating indicia 78 is associated may also incorporate a date. Alternately, as will be described in the following examples, time may refer to a time interval referenced from some predetermined event or epoch.

Correspondingly, the time indicating indicia 78 may comprise a multi-digit alphanumeric code signifying a time of day. The multi-digit code may signify the print time, for example, to within a fraction of a second. The time indicating indicia 78 may represent its corresponding time in any number of ways. As one example, in which the time indicating indicia 78 signifies the time using an eight-digit number, the first and second digits may correspond to the hour, the third and fourth digits may correspond to the minute, the fifth and six digits may correspond to the second, and the seventh and eighth digits may correspond to the hundredth of a second. Accordingly, the time of 11:32:35.50 (in HH:MM:SS.SS format) may be printed on the offer document 64 as 11323550.

As another example, in which the time indicating indicia 78 signifies the time using an eight-digit number, the eight-digit number may reflect the time in number of seconds. For instance, the same time of 11:32:35.50 may be rendered on the offer document as 41555.500 [(11 hrs*3600 sec/hr)+(32 min*60 sec/min)+35.500 sec=41555.500 sec]. By generating the time indicating indicia 78 in this fashion, the corresponding time can be represented to the thousandth of a second. According to one or more embodiments, the time indicating indicia 78 may signify the time using whole numbers. Accordingly, the resultant eight-digit number may be multiplied by one thousand to obtain 41555500.

As yet another example similar to the one above, the time indicating indicia 78 may correspond to a tick count. The tick count may be a number representing the current time relative to some point in time. For instance, the tick count may return the number of ticks elapsed since the occurrence of an event. Typically, a tick may correspond to 1/60th of a second, although other tick values may be employed. Moreover, the event or point in time from which the tick count is based may be rare such that the tick count may rarely be reset. Accordingly, the time indicating indicia 78 may likely be a large, unique integer.

Similar to a tick count, the time indicating indicia 78 may also be a date code, such as a Julian data code or Gregorian date code. The date code may be represented to within a fraction of a second. For instance, a Julian date is the interval of time in days and fractions of a day since Jan. 1, 4713 BC Greenwich noon. The Julian day number is the integer part of the Julian date. For example, the Julian day number for Feb. 16, 2011 is 2455609. Fractions of a day can be conveyed after the decimal in a Julian date, as shown below:

0.1=2.4 hours or 144 minutes or 8640 seconds

0.01=0.24 hours or 14.4 minutes or 864 seconds

0.001=0.024 hours or 1.44 minutes or 86.4 seconds

. . .

0.000000001=0.000000024 hours or 0.00000144 minutes or 0.0000864 seconds

Therefore, by providing a Julian date having as many as nine digits beyond the decimal, for example, a time interval can be established to within approximately 1/10,000^{th} of a second. According to one or more embodiments, the time indicating indicia 78 may be encrypted. For instance, a Julian date code, including the decimal parts, having as many as sixteen or more digits may be generated. The Julian date code may be hashed into the final time indicating indicia 78 that is applied or otherwise integrated into the offer document 64. The hashed result may be a number having more or less digits than the original Julian date. For example, the time indicating indicia 78, once encrypted, may be a nine digit number. In other embodiments, the encrypted time indicating indicia may be five to fifteen digits or seven to eleven digits. The encrypted time indicating indicia may also be decrypted to obtain the original time information or date code.

Instead of a true Julian date code, the time indicating indicia 78 may be associated with the Reduced Julian Day, Modified Julian Day, Truncated Julian Day, Dublin Julian Day, Chronological Julian Day, or the like. Of course, alternative methods for determining the time indicating indicia 78 are fully contemplated herein and may be employed without departing from the scope of the present application.

The time indicating indicia 78 may employ greater or fewer digits to signify the corresponding time depending on the implementation of the offer distribution system 10. In this regard, the time indicating indicia 78 may provide a quasi-unique identifier based on a frequency of events. For instance, the greater the number of print requests anticipated in a given time frame, the greater the resolution of the time indicating indicia 78 (e.g., how finely it parses the time into increments). Hence, the more resolution required may lead to more digits contained in the time indicating indicia 78. The time indicating indicia 78 may be quasi-unique in that it is theoretically possible for the same indicia to be generated for different print requests (e.g., multiple print requests for an offer were received at the exact same time to the fraction of a second), but it is statistically improbable.

The time indicating indicia 78 may be displayed on the printed offer documents 64 in order to reduce offer piracy and enforce offer accountability based on the ability to match the printed offer to its source of printing, e.g., the print applet that was responsible for the offer printing. For instance, the time indicating indicia 78 may be numerically displayed on an offer document 64, or may be integrated into another code such as a barcode 80, or both. The time indicating indicia 78 can be used to track cases of abuse or tampering. In particular, fraudulent activity may be identified should an offer document 64 having the same quasi-unique time indicating indicia 78 be redeemed an excessive number of times.

The time indicating indicia 78 may be added to an offer document 64 as part of a new document layer. According to one or more embodiments, the time indicating indicia 78 may be generated and added to the offer document 64 at the application server 14 before it is distributed to the client device 12. Alternatively, the time indicating indicia 78 may be added at the client device 12 and communicated back to the application server. Additional watermarks may also be applied to the offer document 64 at the time of printing to further reduce piracy. For instance, an anti-copying mark may be applied to the printed offer document 64 to facilitate copy prevention. An anti-copy mark can be a barely visible mark in a document that is “hidden” in a pattern and becomes visible after the document has been copied. The offer document 64 may be decrypted in memory on the fly once the printer has been validated. In this regard, the offer document 64 may never be saved to the client device 12, even in a temporary format.

According to one or more embodiments of the present application, a relationship between an individual user and an offer document 64 printed by the user may not be directly established in order to maintain a level of consumer privacy. In order to accomplish this, the offer supply database 66 and the consumer database 62 may be decentralized with respect to each other, and may not be linked in a relational manner. The offer supply database 66 may be used strictly to track offer supply, while the consumer database 62 may simply track consumer activity.

With reference back to FIG. 3, in addition to storing information relating to a number of offers available for distribution to consumers, the offer supply database 66 may include a number of transaction records consisting of information relating to the issuance and secure printing of offer documents 64. Each transaction record may consist of the printed offer document 64 and the time indicating indicia 78 corresponding to the printing operation.

The consumer database 62 may store information relating to one or more users, such as a consumer name, user name, password, household, location, the unique certificate, preferences, and the like. The consumer database 62 may also include a number of consumer activity records. Each consumer activity record may include information relating to a user and time stamps for when the user logged into and out of the system. Though information corresponding to user activity may be collected, none of the activities may be tied to a specific offer document 64, as these processes may be segmented by design. Alternatively, the consumer database 62 may store printed offer identifying information 68 and associated time indicating indicia 78.

As described, printed offer documents 64 may be associated with a time, rather than with individual consumers or client devices 12. Time indicating indicia 78 may be applied to a printed offer document 64 and recorded in the offer supply database 66. Therefore, no unique information at the local client level (e.g., consumer ID, computer ID, etc.) may be associated with offer information stored in the offer supply database 66 maintained at the server level when an offer document 64 is printed or otherwise issued to the user. Individual offer redemption activity can be tracked through standard clearing practices and can be treated as standard offers (e.g., coupons) delivered to a physical address through a direct mailing campaign where nothing in the redemption is identifiable to the individual consumer.

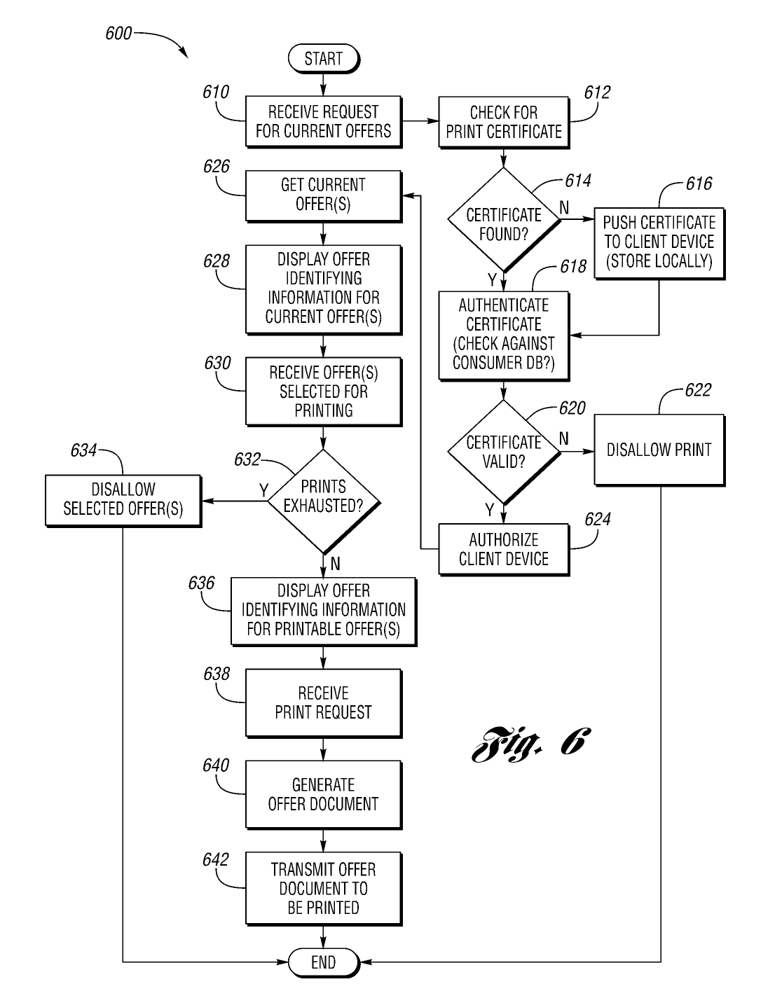

With reference now to FIG. 6, an exemplary flow chart 600 depicting a method according to one or more embodiments of the present application is illustrated. As seen therein, a request to view current offers may be received from the user through the web-based user interface 56, at step 610. The request for current offers may include submitting login credentials to the application server 14 through the user interface 56. The login credentials may include a user name and password. Once valid login credentials are received, the application server 14 may authenticate the client device 12. According to one or more embodiments, login credentials may not be required to identify the client device 12 and/or display offer identifying information 68 corresponding to one or more available offers. Rather, a print request may occur anonymously. An anonymous request to print one or more offer documents 64 from a client device 12 may trigger the application server 14 to authenticate the client device 12. In particular, the application server 14 may check for a print certificate 74 stored locally on the client device 12, at step 612. This may include running a script embedded into a web page of the user interface 56. Correspondingly, at step 614 the application server 14 can determine whether a print certificate 74 is found.

If no print certificate 74 was found, the application server 14 may push a print certificate to the client device 12, at step 616. The print certificate 74 may be stored locally on the client device 12 for subsequent call-up. The print certificate 74 may also be stored in the consumer database 62 or other database. The print certificate 74 may be associated with the user if the user is logged in to the application server 14. After the print certificate 74 is pushed to the client device, the application server 14 may then authenticate the print certificate by checking the print certificate stored locally on the client device 12 against the print certificate stored in the consumer database 62, at step 618. If, on the other hand, a print certificate 74 was found on the client device 12, then it may not be necessary to push a print certificate to the client device. Accordingly, the method may proceed directly to step 618 to authenticate the print certificate 74 by checking the print certificate stored locally on the client device 12 against the print certificate stored in the consumer database 62. At step 620, the application server 14 may next determine whether the print certificate 74 is valid. If the print certificate 74 at the client device 12 is not a valid print certificate, then the user interface 56 may not activate the offer print function or may disallow a print request, as shown at step 622. If, however, the certificate is deemed valid, the client device 12 may be authorized (step 624) and the application server 14 may obtain one or more available offers from the offer supply database 66 (step 626). Offer identifying information 68 corresponding to the one or more available offers may be displayed at the user interface 56 for viewing by the user at step 628.

Next, the user may choose one or more of the available offers to print. Correspondingly, at step 630 a number of selected offers may be received from the user through the user interface 56. Upon receipt of the number of selected offers, the application server 14 may confirm the availability of each of the number of selected offers for printing. To this end, at step 632 the application server 14 may determine whether a predetermined print limit for one or more of the selected offers has been reached. A predetermined print limit may include a campaign-based print limit or a device-based print limit. Correspondingly, the system 10 may determine whether the number of overall prints for a particular offer has been exhausted. The system 10 may check for offer availability against a global print limit and an individual, device-based print limit. The checks may be performed on the application server 14 against an individual print tracking database. If a predetermined print limit for an offer has been exceeded, then the system 10 may preclude the user from printing that offer, for instance, by deactivating the print button, as shown at step 634. If, on the other hand, the number of prints for a particular offer has not been exhausted, offer identifying information 68 for one or more printable offers may be displayed to the user via the user interface at step 636.

If a user wishes to print an offer from the one or more printable offers, the user may select the corresponding print button from the user interface 56. At step 638, the user interface 56 may receive the print request and launch the secure file transfer applet 76 on the client device 12. Accordingly, the application server 14 may generate the offer document 64 from the offer identifying information 68 retrieved from the offer supply database 66 at step 640. The offer document 64 may include at least a portion of the offer identifying information 68 and time indicating indicia 78 associated with the request to print. The secure file transfer applet 76 may verify a valid local printer has been selected by the user. The offer document 64 may then be sent to the local printer without being displayed or stored on the client device 12 at step 642.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A computer-implemented method for distributing an offer comprising:
generating an electronic form for displaying offer identifying information relating to the offer on a client device;
receiving a request from the client device to print an offer document corresponding to the offer;
generating the offer document including time indicating indicia associated with the request to print; and
transmitting the offer document to the client device for printing with the time indicating indicia.

2. The method of claim 1, wherein the time indicating indicia is associated with the time the request to print is received.

3. The method of claim 1, wherein the time indicating indicia is associated with the time the offer document is transmitted to the client device.

4. The method of claim 1, wherein the time indicating indicia is associated with the time the offer document is printed.

5. The method of claim 1, wherein the time indicating indicia is a quasi-unique identifier.

6. The method of claim 5, wherein the time indicating indicia represents a time to within a fraction of a second.

7. The method of claim 5, wherein the time indicating indicia is encrypted.

8. The method of claim 5, wherein the time indicating indicia corresponds to an alphanumeric code printed on the offer document.

9. The method of claim 8, wherein the time indicating indicia is additionally integrated into a barcode.

10. The method of claim 1, wherein the time indicating indicia is associated with a Julian date code.

11. The method of claim 10, wherein the time indicating indicia is generated from an encryption of the Julian date code.

12. The method of claim 1, wherein the time indicating indicia is associated with a tick count.

13. The method of claim 1, further comprising:
generating a transaction record associated with the print request including the offer identifying information and the time indicating indicia; and
storing the transaction record in a database.

14. A computer system for distributing an offer including a computer and a database that are in electronic communication with each other, the computer system having a central processing unit (CPU) for executing machine instructions and a memory for storing machine instructions that are to be executed by the CPU, the machine instructions when executed by the CPU implement the following functions:
generating a web page for displaying offer identifying information relating to the offer on a client device;
receiving a request from the client device to print an offer document corresponding to the offer;
generating the offer document including at least a portion of the offer identifying information and time indicating indicia associated with the request to print; and
transmitting the offer document to the client device for printing with the time indicating indicia.

15. The computer system of claim 14, wherein the time indicating indicia is a quasi-unique identifier.

16. The computer system of claim 15, wherein the time indicating indicia represents a time to within a fraction of a second.

17. The computer system of claim 15, wherein the time indicating indicia is encrypted.

18. The computer system of claim 17, wherein the time indicating indicia corresponds to an alphanumeric code printed on the offer document.

19. The computer system of claim 18, wherein the time indicating indicia is additionally integrated into a barcode.

20. The computer system of claim 15, wherein the time indicating indicia is associated with a Julian date code.

21. The computer system of claim 15, wherein the time indicating indicia is associated with a tick count.

22. The computer system of claim 14, wherein the machine instructions when executed by the CPU further implement the following functions:
generating a transaction record associated with the print request including the offer identifying information and the time indicating indicia; and
storing the transaction record in a database.

23. An offer document for printing at a client device comprising:
offer identifying information corresponding to an offer; and
time indicating indicia associated with a request to print the offer document.

24. The offer document of claim 23, wherein the time indicating indicia is associated with a time the request to print is received.

25. The offer document of claim 23, wherein the time indicating indicia is associated with a time the offer document is transmitted to the client device.

26. The offer document of claim 23, wherein the time indicating indicia is associated with a time the offer document is printed.

27. The offer document of claim 23, wherein the time indicating indicia is a quasi-unique identifier.

28. The offer document of claim 27, wherein the time indicating indicia represents a time to within a fraction of a second.

29. The offer document of claim 27, wherein the time indicating indicia is encrypted.

30. The offer document of claim 27, wherein the time indicating indicia corresponds to an alphanumeric code printed on the offer document.

31. The offer document of claim 30, wherein the time indicating indicia is additionally integrated into a barcode on the offer document.

32. The offer document of claim 23, wherein the time indicating indicia is associated with a Julian date code.

33. The offer document of claim 23, wherein the time indicating indicia is associated with a tick count.
